(19) United States
(12) Patent Application Publication
(10) Pub. No.: US 2019/0099704 A1
(43) Pub. Date: Apr. 4, 2019

(54) SYSTEMS AND PROCESSES FOR FILTERING WATER WITH ULTRAFINE GRANULAR MEDIA

(71) Applicant: THE UNIVERSITY OF NORTH CAROLINA AT CHARLOTTE, Charlotte, NC (US)

(72) Inventors: James E. AMBURGEY, Kannapolis, NC (US); Derek FRENCH, Toronto (CA)

(21) Appl. No.: 16/148,660

(22) Filed: Oct. 1, 2018

Related U.S. Application Data
(60) Provisional application No. 62/565,231, filed on Sep. 29, 2017.

(51) Int. Cl. B01D 39/06; B01D 24/10; C02F 1/00

(52) U.S. Cl. CPC B01D 39/06; B01D 24/105; C02F 2103/42; C02F 2303/04; C02F 1/004

(57) ABSTRACT

A system for filtering water is described herein, the system comprising a granular filter media having an effective size of 0.05 mm to 0.4 mm. In some embodiments, a granular filter media described herein comprises a ceramic, a sand, a glass, a zeolite, a garnet, an anthracite coal, an activated carbon, an ilmentite, or any combination thereof. In some instances, a layer of granular filter media described herein has a flow rate of up to 12 gpm/ft², and is capable of filtering out materials having an average size in three dimensions of 1 μm or larger without requiring any type of coagulation to alter the surface properties of the particles.

### RELATED APPLICATION DATA

This application claims priority under 35 U.S.C. § 119(e) to U.S. Provisional Patent Application No. 62/565,231, filed Sep. 29, 2017, which is hereby incorporated by reference in its entirety.

### FIELD

The invention is generally related to water filtration, and more specifically, to pool water filtration using ultrafine granular filter media.

### BACKGROUND

There are three common types of filters in use in swimming pools worldwide-sand-based depth filters, membrane-based cartridge filters, and surface filtration-based precoat filters. Sand-based filters typically contain a layer of sand having an effective size of 0.4-0.8 mm with a typical depth (length) of 10-40 inches. Sand filters are often referred to as depth filters, which generally capture contaminants within the filtering media itself, as opposed to membrane and precoat filters, which typically trap contaminants on a surface of the filtering media. Generally depth filters can retain a high load of contaminant particles that clog slowly throughout the depth of the filter bed over time. Protozoan parasite removal in a sand filter is generally 20-50% per pass without chemical pretreatment.

Membrane-based cartridge filters typically use a pleated membrane material having an average pore size of 30 microns. Removal of particles in the size range of protozoan parasites (˜4.5 microns) is typically 10-40% per pass for membrane-based cartridge filters of 30 micron. While membrane-based filters can filter out very small particles, their useful lifespan is short, because once the pores on the surface become clogged with particulates, the filter has to be changed.

Precoat filters use a much finer filter media than depth filters, usually a powder having an effective size of 0.03 to 0.05 mm. This fine of a filter media is often used at a media depth of only 1/16″ to ⅛″. Precoat filtration is typically called surface filtration since the media depth is usually less than or equal to ⅛-inch, and can achieve 4.5 micron particle removals in excess of 99%. The disadvantage of precoat filtration is that the very small particle sizes of the powdered filtration media can lead to dense packing that can quickly become clogged by contaminant particles, and the relative thinness of the precoat media layer means that the media layer has a very small loading contaminant loading capacity, so contaminants can leach out. Additionally, since the precoat media is often a powder, replacement of the spent precoat media can present an inhalation hazard.

Attempts to use precoat filtration media as a primary material in depth filters, rather than larger-sized sand, have been largely unsuccessful. The ultrafine, powdered precoat filtration media exhibits high packing density, which dramatically increases the tortuosity for passing water, which in turn, dramatically reduces water flow rates through the media as the thickness of the media increases. Moreover, the ultrafine powders of precoat filtration media are difficult to contain within high-flow filters, and often escape into pools, spas, and other recreational waters.

Therefore, there remains a need for improved filtration media, including for applications involving the purification of water for recreational use.

### SUMMARY

A filtering system is described herein that has a pathogen removal capability similar to that of a precoat filter, with one or more advantages of a depth filter, such as a high particle loading capacity, reusable filter media, no inhalation hazards of a silica powder, simple operation, and easy maintenance.

In one aspect, a system for filtering water can comprise a granular filter media having an effective size of 0.05 mm to 0.4 mm. A granular filter media described herein can comprise a ceramic, a sand, a glass, a zeolite, a garnet, an ilmentite, or any combination thereof. The granular filter media can have a zero or positive zeta potential at neutral pH, and can have an approximately spherical shape

A granular filter media described herein can in some instances comprise a plurality of surface pores having a diameter of 500 nm to 75 μm. In some instances, a layer of granular filter media can have a flow rate of up to 12 gpm/ft².

In some embodiments, a granular filter media has a porosity of 30% to 55%

In some embodiments, a system described herein can comprise a downstream layer comprising the granular filter media; and an upstream layer comprising a low density filter media having an effective size that is larger than the average particle size of the granular filter media. A low density filter media described herein can have an effective size of 0.45 mm or larger, and in some instances, can comprise a carbonaceous material, a sand, a glass, a zeolite, a ceramic, or any combination thereof.

In another aspect, a method of filtering water is described herein, and comprises passing water through a layer of granular filter media described herein having an effective size of 0.05 mm to 0.4 mm; and filtering out materials having an average size in three dimensions of 1 μm or larger. In some instances the water is passed through a layer of granular filter media described herein at a rate of up to 12 gpm/ft².

In some embodiments, a layer of granular filter media is a downstream layer and a layer of low density filter media is an upstream layer.

In some instances, materials filtered out by a method described herein include microorganisms comprising Cryptosporidium ssp, Giardia ssp, or both. In some embodiments, a step of filtering of materials occurs in an absence or presence of chemical pretreatment.

### BRIEF DESCRIPTION OF THE DRAWINGS

FIG. 1 is a scanning electron microscope (SEM) image of exemplary granular filter media;

FIG. 2 is an SEM image of a ceramic-based granular filter media;

FIG. 3 is an SEM image of a glass microbead filter media;

FIG. 4 is a sectional view of a granular filter material packed in a column;

FIG. 5 is a sectional view of a column packed with a layer of granular filter material and a layer of low density filter material;

FIG. 6 is a graphical illustration of filter effluent turbidity after using different types of filter media;

FIG. 7 is a graphical illustration of effluent particle counts after using different types of filter media;

FIG. 8 is a graphical illustration of head loss (average pressure drop) in columns packed with different types of filter media; and

FIG. 9 is a graphical illustration of 5-micron microsphere removal properties of ultrafine ceramic filter media verses zeolite.

### DETAILED DESCRIPTION

Embodiments described herein can be understood more readily by reference to the following detailed description and examples. Elements, apparatus and methods described herein, however, are not limited to the specific embodiments presented in the detailed description and examples. It should be recognized that these embodiments are merely illustrative of the principles of this disclosure. Numerous modifications and adaptations will be readily apparent to those of skill in the art without departing from the spirit and scope of the disclosure.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, such as 1.0 to 5.3, or 4.7 to 10.0, or 3.6 to 7.9.

All ranges disclosed herein are also to be considered to include the end points of the range, unless expressly stated otherwise. For example, a range of “between 5 and 10,” “from 5 to 10,” or “5-10” should generally be considered to include the end points 5 and 10. Further, when the phrase “up to” is used in connection with an amount or quantity, it is to be understood that the amount is at least a detectable amount or quantity. For example, a material present in an amount “up to” a specified amount can be present from a detectable amount and up to and including the specified amount.

Recreational water, as described herein is generally referred to as water used for recreational purposes, such as water used in recreational facilities, such as a pool, a hot tub, a spa, a water park, and other locations where water will be in contact with a user of the facility. Generally, recreational water is nonpotable water, which is water not fit for user consumption as drinking water. However, recreational water can be incidentally consumed by a user during use of a recreational facility, and therefore often must conform to minimum purity standards usually mandated by governmental entities.

I. Filtering System

In an aspect, a system for filtering water is described herein. In some embodiments, a system for filtering water, such as swimming pool water or other recreational water, using an ultrafine granular filter media is described herein. In some instances, a system described herein can filter water to produce drinking water using an ultrafine granular filter media described herein. This system can in some instances significantly improve the removal of protozoan parasites known to cause waterborne disease outbreaks in swimming pools (such as Cryptosporidium and Giardia), produce cleaner, clearer pool water, and/or produce cleaner potable water. In some embodiments, a system described herein can be used without any chemical pretreatment to remove particles or microbes measuring 1 micron or greater in diameter. While a system described herein can be used without chemical pretreatment, in some cases the system can be compatible with chemical pretreatments such as the use of coagulants. In some embodiments, ultrafine granular filter media described herein can be used alone or in combination with larger filter media.

In some embodiments, a system for filtering water comprises a granular filter media. In some instances, a granular filter media described herein comprises a layer. A granular filter media can comprise a ceramic, a sand, a glass, a zeolite, a garnet, an ilmentite, or any combination thereof.

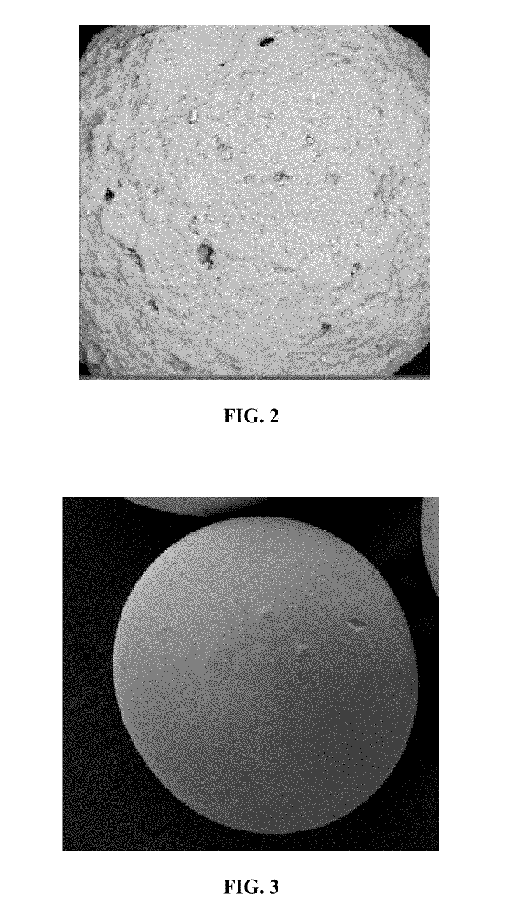

In some embodiments, a granular filter media described herein comprises a surface roughness that is greater than a surface roughness of other common filtering media. An increased surface roughness of the granular filter media over a comparatively smooth crystalline surface of other common filtering media can exhibit increased contaminant particle attachment potential to the granular filter media through increased surface are per unit volume, and/or greater adhesion potential of contaminant particles to the surface of a granular filter media. As an example, FIG. 2 shows a scanning electron microscope (SEM) image of an exemplary granular ceramic filter media having a surface roughness that is comparatively greater than a glass-based microbead filter media shown in FIG. 3.

In some instances, a granular filter media described herein can be an ultrafine granule, where grain size is expressed in an effective size. An effective size as described herein is a particle size based on sieve opening where 10% of the particles in a sample (by mass) are finer/small, while 90% are larger. This is typically referred to as “D10” or “Effective Size”. For example, a granular filter media described herein can have an effective size of 0.05 to 0.4 mm, 0.1 to 0.4 mm, 0.15 to 0.4 mm, 0.2 to 0.4 mm, 0.25 to 0.4 mm, 0.3 to 0.4 mm, 0.35 to 0.4 mm, 0.05 to 0.35 mm, 0.05 to 0.3 mm, 0.05 to 0.25 mm, 0.05 to 0.2 mm, 0.05 to 0.15 mm, 0.05 to 0.1 mm, 0.10 to 0.3 mm, 0.15 to 0.25 mm, 0.20 to 0.40 mm, or 0.25 to 0.35 mm. In some cases, a granular filter media has a particle size of 30 to 90 mesh, 40 to 80 mesh, 50 to 70 mesh, 60 to 80 mesh, or 40-60 mesh. In some embodiments, a granular filter media can comprise a single average particle size. However, in other embodiments, a granular filter media can comprise a mixture of two distinct average particle sizes. For example, a first granular filter media having a first effective size can be combined with a second granular filter media having a second effective size that is different from the first average particle size.

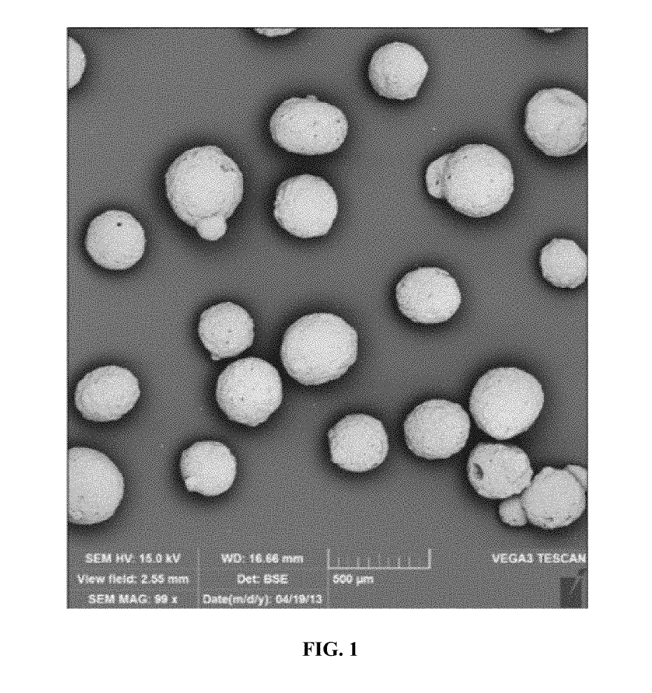

A granular filter media described herein can have any shape not inconsistent with the objectives of this disclosure. In some instances, a granular filter media can be approximately spherical, as shown for example in FIG. 1, which shows spherical granular ceramic filter media. A spherical granular filter media can in some embodiments display certain desirable physical properties over non-spherical filter media. For example, a spherical granular filter media can pack less densely than some angular media, which can offer improved hydraulics capacity, such as lower head loss. However, a granular filter media described herein is not solely limited to spherical granular filter media, but can in some embodiments can be triangular, cylindrical, squared, rectangular, hexagonal, or any other granular shape not inconsistent with the objectives of this disclosure.

In some embodiments, a granular filter media described herein can have a zero or positive zeta potential at neutral pH. In some instances, a granular filter media has a zeta potential of 0 to +30 mV, 0 to +25 mV, 0 to +20 mV, 0 to +15 mV, 0 to +10 mV, 0 to +9 mV, 0 to +8 mV, 0 to +7 mV, 0 to +6 mV, 0 to +5 mV, 0 to +4 mV, 0 to +3 mV, 0 to +2 mV, 0 mV, +1 mV, +2 mV, +3 mV, +4 mV, +5 mV, +6 mV, +7 mV, +8 mV, +9 mV, +10 mV, or greater than +10 mV. While not intending to be bound by theory, it is believed that granular filter media having a zero to positive zeta potential, such as ceramic-based granular filter media, can reduce electrostatic repulsion between negatively charged particles and a negatively charged filter media surface, thereby increasing particle removal.

A granular filter media described herein can comprise a plurality of surface pores in some embodiments, each surface pore having an opening diameter in a range 500 nm to 75 μm, 750 nm to 75 μm, 1 to 75 μm, 10 to 75 μm, 20 to 75 μm, 30 to 75 μm, 40 to 75 μm, 50 to 75 μm, 60 to 75 μm, 1 to 75 μm, 1 to 65 μm, 1 to 55 μm, 1 to 45 μm, 1 to 40 μm, 1 to 30 μm, 1 to 20 μm, or 1 to 15 μm.

In some embodiments, a granular filter media can have a porosity of 30 to 55%, where porosity is a volume of pores (empty space) divided by a total volume of granular filter media. In some instances, a granular filter media described herein can have a porosity of 35 to 55%, 35 to 50%, 35 to 45%, or 30 to 40%.

A granular filter media described herein can have a water flow rate of a volume sufficient for recreational water use, such as a flow rate sufficient to filter pool or spa water. In some cases, a granular filter media described herein can have a water flow rate of a volume sufficient for filtering drinking water. In some embodiments, a granular filter media can have a water flow rate of up to 1 gpm/ft², up to 2 gpm/ft², up to 3 gpm/ft², up to 4 gpm/ft², up to 5 gpm/ft², up to 6 gpm/ft², up to 7 gpm/ft², up to 8 gpm/ft², up to 9 gpm/ft², up to 10 gpm/ft², up to 11 gpm/ft², up to 12 gpm/ft², 1 to 12 gpm/ft², 2 to 12 gpm/ft², 3 to 12 gpm/ft², 4 to 12 gpm/ft², 5 to 12 gpm/ft², 6 to 12 gpm/ft², 7 to 12 gpm/ft², 8 to 12 gpm/ft², 9 to 12 gpm/ft², 10 to 12 gpm/ft², 10 to 12 gpm/ft², 8 to 10 gpm/ft², 7 to 11 gpm/ft², 7 to 10 gpm/ft², or 7 to 9 gpm/ft².

In some embodiments, a system described herein can comprise a layer granular filter media. A layer of granular filter media can comprise a depth of at least 8 in, at least 9 in, at least 10 in, at least 11 in, at least 12 in, at least 13 in, at least 14 in, at least 15 in, at least 16 in, at least 17 in, at least 18 in, at least 19 in, at least 20 in, at least 25 in, at least 30 in, at least 35 in, at least 40 in, at least 45 in, greater than 50 in, 8 to 25 in, 10 to 25 in, 12 to 25 in, 15 to 25 in, 17 to 25 in, 20 to 25 in, 22 to 25 in, 8 in, 9 in, loin, 11 in, 12 in, 13 in, 14 in, 15 in, 16 in, 17 in, 18 in, 19 in, 20 in, 21 in, 22 in, 23 in, 24 in, or 25 in.

In some embodiments, a layer of granular filter media described herein can filter out particles and microbes having an average size in three dimensions of less than 1 μm, 1 μm or larger, 2 μm or larger, 3 μm or larger, 4 μm or larger, 5 μm or larger, 6 μm or larger, 7 μm or larger, 8 μm or larger, 9 μm or larger, 10 μm or larger, 2 to 6 μm, 2 to 5 μm, 2 to 4 μm, 3 to 6 μm, or 4 to 6 μm. In some instances, a layer of granular filter media described herein can filter out particles and microbes having the above described average sizes with an efficiency of at least 50%, 60%, 70%, 80%, 85%, 90%, 95%, greater than 90%, or greater than 95%. In some cases, a layer of granular filter media described herein can filter out particles and microbes 1 μm or larger with an efficiency of at least 90%. In some embodiments, a layer of granular filter media having a depth of at least 8 in or 8 in to 25 in can filter out particles and microbes having a size of 1 μm or greater without the use of a coagulant, and at a flow rate of up to 12 gpm/ft².

In some instances, a system described herein can further comprise one or more additional filtering media layers in combination with a granular filter media layer. For example, in some embodiments, a system can comprise a low density filter media having an effective size that is larger than an effective size of the granular filter media. A low density filter media described herein can an effective size of 0.4 to 3 mm, 0.5 to 3 mm, 0.6 to 3 mm, 0.7 to 3 mm, 0.8 to 3 mm, 0.9 to 3 mm, 1 to 3 mm, 1.3 to 3 mm, 1.5 to 3 mm, 1.7 to 3 mm, 2 to 3 mm, 2.3 to 3 mm, 0.4 to 2.9 mm, 0.4 to 2.8 mm, 0.4 to 2.7 mm, 0.4 to 2.6 mm, 0.4 to 2.3 mm, 0.4 to 2 mm, 0.4 to 1.7 mm, 0.4 to 1.5 mm, 0.4 to 1.3 mm, 0.4 to 1 mm, 0.4 to 0.7 mm, 0.4 mm or larger, 0.5 mm or larger, 0.6 mm or larger, 0.7 mm or larger, 0.8 mm or larger, or 0.9 mm or larger. In some embodiments, a system can comprise a low density filter media having an effective size that is approximately equal to an effective size of a granular filter media.

A low density filter media can comprise a carbonaceous material, a sand, a glass, a zeolite, a ceramic, or any combination thereof. Any carbonaceous material not inconsistent with the objectives of this disclosure can be used, such as anthracite coal, activated charcoal, and the like. A low density sand, glass, zeolite, or ceramic can be made of the same types of materials as a sand-, glass-, zeolite-, or ceramic-based granular filter media described herein, but can have a higher number of, or larger sized, pores than the granular filter media.

In some embodiments, a system described herein can comprise a downstream layer comprising a granular filter media; and an upstream layer comprising a low density filter media. As water passes through the upstream layer, larger particulates and materials can be filtered out prior to passing through the granular filter media. By removing these larger particulates and materials prior to the water passing through the granular filter media, the lifetime of the granular filter media can be extended, because the larger particulates and materials will not clog the pores and openings in the granular filter media layer. However, in other embodiments, a system described herein can comprise a downstream layer comprising a low density filter media; and an upstream layer comprising a granular filter media.

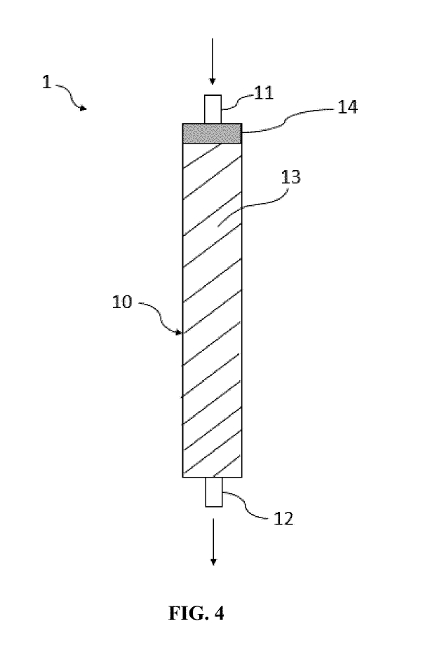

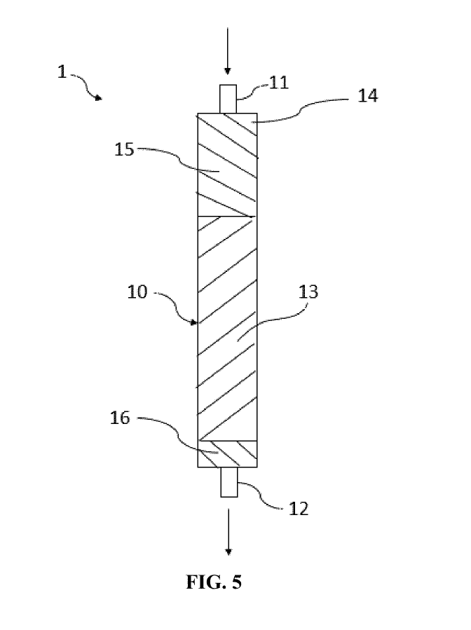

FIGS. 4 and 5 illustrate various systems described herein for filtering water. In some embodiments, a system 1 described herein can comprise a column 10 having an inlet 11 proximate a first end and an outlet 12 proximate an opposing second end. A column 10 can have a centrally located filter media receiving space for receiving filter media. Water flow is illustrated using arrows, where water enters inlet 11, passes through the filtering media, and exits through outlet 12. In some embodiments, an optional orifice plate 14 can be positioned proximate to a first end of column 10 to limit backwashing flow rates, or in other instances can be positioned proximate to a second end of column 10 to limit both backwashing and filtration rates. In some embodiments, an orifice plate 14 can be positioned proximate to both a first end and a second end of column 10. In some embodiments, an optional fine gravel layer 16 can being positioned between outlet 12 and filtering media in the filter media receiving space to prevent filtering media from exiting column 10 through outlet 12.

In an embodiment shown in FIG. 4, a single type granular filter media 13 described herein is positioned in a filter media receiving space of column 10. An optional orifice plate 14 is positioned proximate to a first end of the column 10. A fluid, such as recreational water, enters into the column 10 through inlet 11, passes through the granular filter media 13, and exits through outlet 12. While not shown, an optional fine gravel layer can be positioned between the granular filter media 13 and outlet 12, and/or a second orifice plate can be positioned proximate to a second end of column 10.

In an embodiment shown in FIG. 5, a layer of granular filter media 13 is positioned in the filter media receiving space of column 10 as a downstream layer, and a layer of low density filter media 15 forms an upstream layer. An optional fine gravel layer 16 is positioned between outlet 12 and the granular filter media 13 layer. A fluid, such as water, enters into the column 10 through inlet 11; passes through the low density filter media 15, granular filter media 13 and optional gravel layer 16; and exits through outlet 12. While not shown, an optional orifice plate 14 can be positioned between the low density filter media 15 layer and inlet 11, and/or between the granular filter media 13 layer and outlet 12.

In some instances, a system described herein, such as the system described in FIG. 4 or 5, can comprise column 10 connected to a swimming pool, where recreational water from the swimming pool enters into column 10 through inlet 11, is filtered through at least a layer of granular filter media 13, exits column 10 through outlet 12, and is discharged back into the swimming pool.

In some instances, a system described herein, such as the system described in FIG. 4 or 5, can comprise column 10 connected to a hot tub or spa, where recreational water from the hot tub or spa enters into column 10 through inlet 11, is filtered through at least a layer of granular filter media 13, exits column 10 through outlet 12, and is discharged back into the hot tub or spa.

In some embodiments, a system described herein, such as the system described in FIG. 4 or 5, can comprise column 10 connected to a water source, where water from the water source enters into column 10 through inlet 11, is filtered through at least a layer of granular filter media 13, exits column 10 through outlet 12, and potable drinking water is discharged from column 10.

An example of a conventional drinking water filtration system is a tri-media filter comprising a 3 to 4 in layer of garnet having an effective size of 0.2 to 0.3 mm, a 12 in sand layer, and a 24 in anthracite layer. This conventional tri-media filter cannot remove pathogens with an efficiency of at least 90% without chemical pretreatment (or coagulation), but instead requires chemical pretreatment with a coagulant to be effective. Additionally, this conventional tri-media filter has very low flow rates, such as an upper limit of 4 gpm/ft².

In contrast to the conventional tri-media filter, a system described herein for filtering water can remove pathogens such as Crypto without requiring coagulation, and can do so at a high flow rate, such as 12 gpm/ft². Moreover, in some embodiments, a system described herein can filter pathogens at a high flow rate using a layer of ultrafine granular filter media described herein at a depth at least double that of the garnet layer in a conventional tri-media filter for potable water. A garnet layer have an equivalent depth would have very low flow rates, and would still require coagulants to be effective. A layer of ultrafine granular filter media can have a depth as little as 8 inches to be effective at removing Crypto with 90% efficiency at high flow rates, compared to a 40 in overall depth of the conventional tri-media filter for drinking water (that requires coagulation) at low flow rates.

II. Method of Filtering Water

In another aspect, a method of filtering water is described herein. In some embodiments, a method of filtering water comprises passing water through a layer of granular filter media described in Section I, the granular filter media having an effective size of 0.05 mm to 0.4 mm; and filtering out particles having an average size in three dimensions of 1 μm or larger. The water being filtered can be any water source not inconsistent with the objectives of this disclosure. In some instances, the water being passed and filtered is recreational water.

In some embodiments, water is passed through a layer of granular filter media at a rate of up to 12 gpm/ft², 7-11 gpm/ft², 7-10 gpm/ft², 7-9 gpm/ft², 7-8 gpm/ft², 8-12 gpm/ft², 9-12 gpm/ft², 10-12 gpm/ft², 11-12 gpm/ft², 7 gpm/ft², 8 gpm/ft², 9 gpm/ft², 10 gpm/ft², 11 gpm/ft², or 12 gpm/ft².

As previously described in Section I, a method described herein can in some embodiments filter out particles and microbes having an average size in three dimensions of less than 1 μm, 1 μm or larger, 2 μm or larger, 3 μm or larger, 4 μm or larger, 5 μm or larger, 6 μm or larger, 7 μm or larger, 8 μm or larger, 9 μm or larger, 10 μm or larger, 2 to 6 μm, 2 to 5 μm, 2 to 4 μm, 3 to 6 μm, or 4 to 6 μm. In some instances, a method described herein can filter out particles and microbes having the above described average sizes with an efficiency of at least 50%, 60%, 70%, 80%, 85%, 90%, 95%, greater than 90%, or greater than 95%. In some cases, a method described herein can filter out particles and microbes 1 μm or larger with an efficiency of at least 90%.

In some embodiments, a method described herein further comprises a step of passing water through a layer of low density filter media described in Section I, the low density filter media having an effective size that is larger than an average particle size of a granular filter media. In some instances, a method described herein further comprises a step of passing water through a layer of low density filter media described in Section I, the low density filter media having an effective size that is approximately equal to an average particle size of a granular filter media.

A method of filtering water described herein can comprise passing water through a column comprising a layer of granular filter media, such as through column 10 shown in FIG. 4. Using FIG. 4 as an example, a method of filtering water through a column can comprise passing water through inlet 11 into column 10, through an optional orifice plate 14, through a layer of granular filter media 13 described in Section I, through an optional fine gravel layer (shown in FIG. 5), and out of the column 10 through outlet 12; and filtering out particles having an average size in three dimensions of 1 μm or larger as the water passes through the layer of granular filter media 13.

Using FIG. 5 as an example, a method of filtering water through a column can comprise passing water through inlet 11 into column 10; through an optional orifice plate 14 (shown in FIG. 4); through an upstream layer of low density filter media described in Section I; through a downstream layer of granular filter media 13 described in Section I; through an optional fine gravel layer 16; and out of the column 10 through outlet 12; and filtering out particles having an average size in three dimensions of 1 μm or larger as the water passes through the layer of granular filter media 13.

As previously described herein, the water being filtered can occur in an absence of chemical pretreatment. However, in some embodiments, a method described herein can comprise a step of chemically pretreating water before passing the water through granular filter media. Any chemical pretreatment not inconsistent with the objectives of this disclosure can be used. For example, in some embodiments, chlorine, bromine, or a coagulant can be used, such as an aluminum salt (such as aluminum sulfate or polyaluminum chloride), an iron salt, a titanium salt, a zirconium salt, or other metallic salts, or a cationic polymer.

Some embodiments described herein are further illustrated in the following non-limiting examples.

### Example 1

### Comparative Columns

A pilot assembly for comparing filter media types was prepared using two, 2″ diameter clear acrylic filter columns. One column was packed with Ceraflow70™ by Wateropolis Corp, a 0.15-0.25 mm spherical ceramic filter media (“ceramic media”). The second column was packed with various other filter media, such as sand, fine sand, glass microbeads, or zeolite. Each media-packed column was run for extended periods, and column effluent was measured in real time for 2-5 micron sized particles (HACH 2200 PCX), and turbidity was also measured and recorded in real time (GLI Accu4).

### Example 2

### Turbidity

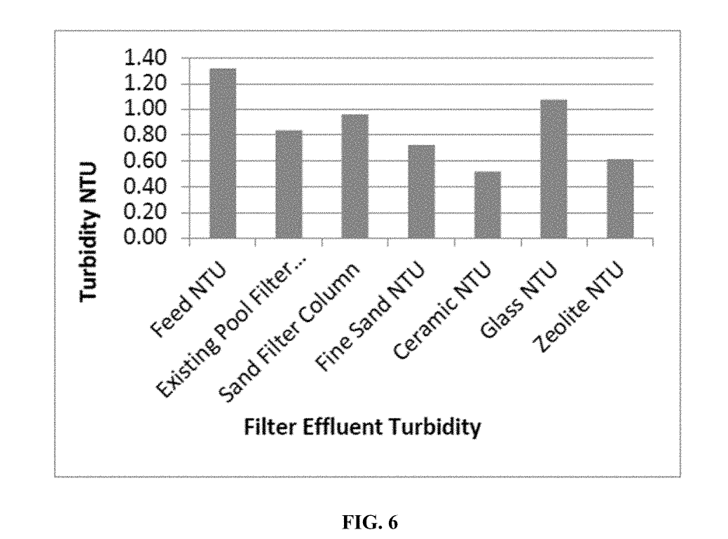

Recreational water from an indoor commercial swimming pool passed through the comparative columns of Example 1 to determine whether various ultrafine granular filter media described herein affected turbidity levels. Baseline pool water influent turbidities during the turbidity test ranged between 0.14 NTU to 2.5 NTU, as depicted in FIG. 6. This variation was correlated to bather load in the pool when the baseline sample was taken. NSF-50 pool media test protocol requires a 70% reduction in effluent turbidity, and, as shown in FIG. 6, an ultrafine granular ceramic media was the only material that achieved at least a 70% reduction in real time test conditions.

### Example 3

### Particle Counts

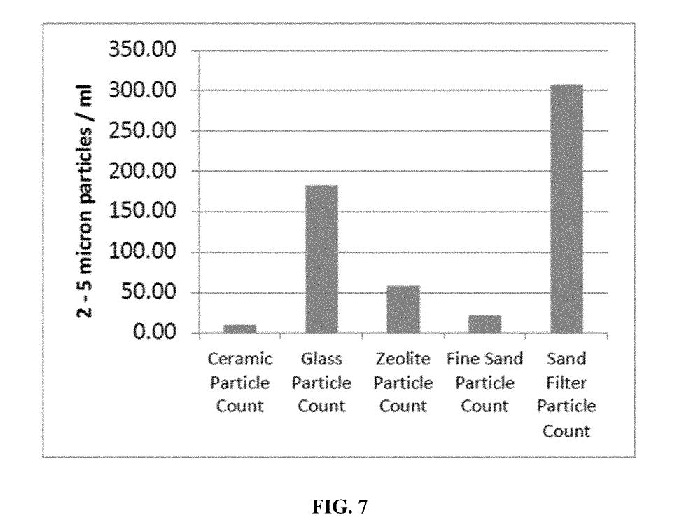

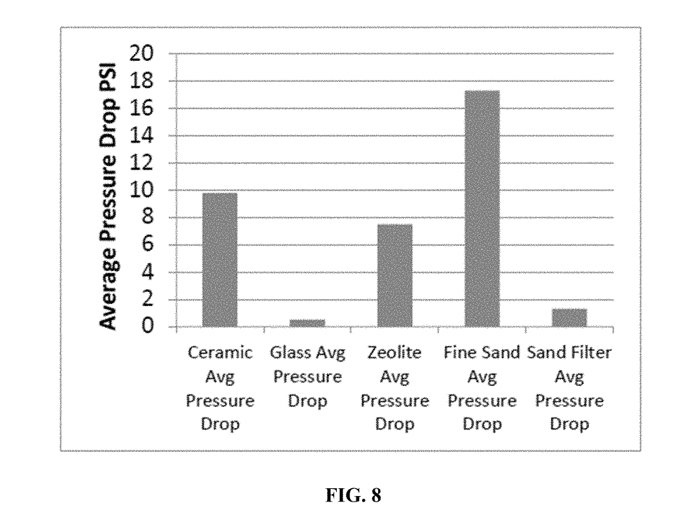

Turbidity removal values generally do not correlate and are not predictive of a filter media's ability to remove Cryptosporidium (“Crypto”) sized particles. Particle count was therefore separately tested by passing recreational water from an indoor commercial swimming pool through the comparative columns and recording at 15 second increments and counting particles in the 2-5 microns (μm) range using a particle counter. This size range was selected based upon the typical size of Cryptosporidium, which are typically larger than 2 microns. Raw influent particle counts were not measured. As shown in FIG. 7, ceramic media effluent particle concentration averaged 9.54 particles per 100/ml, fine grain sand was the next best performing material at 22.1 particles per 100/ml followed by charged zeolite at 58.2 particles per 100/ml.

### Example 4

### Head Loss

Head loss is an accumulation of pressure across an entire filter bed and is an indicator of filter solids loading. Head loss can be used to predict a need for filter backwashing. In FIG. 8, all filter media tested were installed to identical filter bed depths of 24 inches (610 mm) and all filter columns were run at the same flow rate of 12.0 gpm/ft² (29.3 m/hr) using the comparative columns of Example 1. Head loss for each filter media is shown in FIG. 8, with fine sand showing the greatest average pressure drop, with ceramic and zeolite showing more moderate average pressure drop. Glass microbeads and coarse sand displayed very little pressure drop.

Comparing FIGS. 7 and 8, there is a correlation between average filter head-loss and a filter media's ability to remove crypto sized particles, with the exception of the ceramic media. Surprisingly, the ultrafine granular ceramic media displayed low head loss (FIG. 8) while still displaying low particle effluent counts (FIG. 7).

### Example 5

### 5-Micron Microsphere Removal

Ceramic media was tested side by side against a “charged” zeolite media used in Examples 2-4 that had demonstrated the next best overall filter performance to determine 5-micron microsphere removal properties. Fine sand was excluded from the test due to its overly high-pressure loss characteristics (see FIG. 8). For the test, 5-micron, crypto sized luminescent polystyrene microspheres were dosed at the inlets to the comparative columns of Example 1 at a rate that mimicked a fecal incursion.

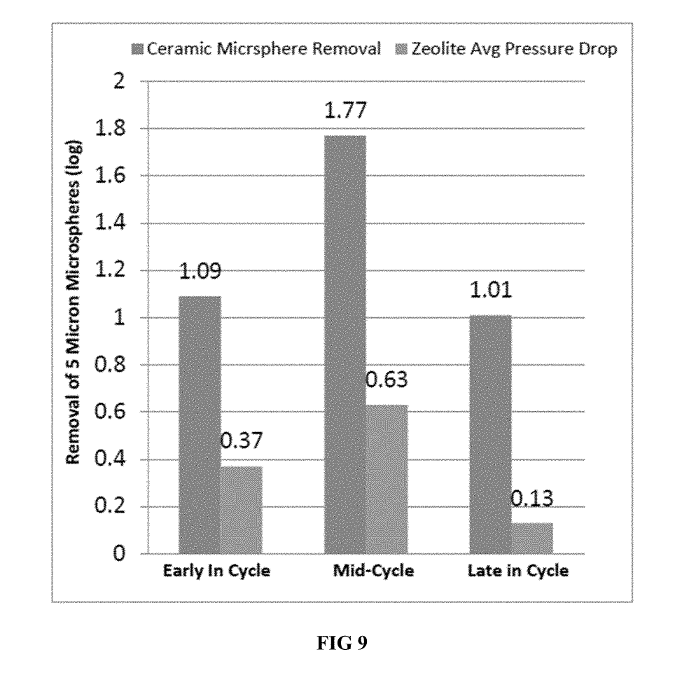

The microsphere testing was done at three points during a typical 7-day continuous filter run. Microspheres were dosed at 3 different times during the filter run, the initial dose at start up before filter “ripening” had occurred. The middle test was done at 3.5 days into the filter run and the final microsphere dose was prior to backwash at the end of the 7 day filter operation. As shown in FIG. 9, zeolite did not perform as well as expected, showing a high of a 0.63 log removal at mid-cycle, and a low of a 0.13 log removal late in the cycle. In contrast, the ceramic filter media provided greater than 1.0 log removal (>90%) removal at all three points in the cycle.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the invention.

1. A system for filtering water, comprising:
a granular filter media having an effective size of 0.05 mm to 0.40 mm.

2. The system of claim 1, wherein the granular filter media comprises a ceramic, a sand, a glass, a zeolite, a garnet, an ilmentite, or any combination thereof.

3. The system of claim 2, wherein the granular filter media has a zero or positive zeta potential at neutral pH.

4. The system of claim 1, wherein the granular filter media comprises a ceramic.

5. The system of claim 1, wherein the granular filter media is approximately spherical.

6. The system of claim 1, wherein the granular filter media comprises a plurality of surface pores having a diameter of 500 nm to 75 μm.

7. The system of claim 1, wherein the granular filter media has a porosity of 20% to 65%

8. The system of claim 1, wherein a layer of the granular filter media has a flow rate of up to 12 gpm/ft².

9. The system of claim 8, wherein the water is sourced from recreational water.

10. The system of claim 1, wherein the granular filter media comprises a layer having a depth of 8 inches or more.

11. The system of claim 1, further comprising:
a downstream layer comprising the granular filter media; and
an upstream layer comprising a low density filter media having an effective size that is larger than the effective size of the granular filter media.

12. The system of claim 11, wherein the low density filter media has an effective size of 0.4 mm or larger.

13. The system of claim 1, wherein the low density filter media comprises a carbonaceous material, a sand, a glass, a zeolite, a ceramic, or any combination thereof.

14. A method of filtering water, comprising:
passing water through a layer of granular filter media having an effective size of 0.05 mm to 0.4 mm; and
filtering out materials having an average size in three dimensions of 1 μm or larger.

15. The method of claim 14, wherein the water is passed through the layer of granular filter media at a rate of up to 12 gpm/ft².

16. The method of claim 14, wherein the layer of granular filter media has a depth of 8 inches or more.

17. The method of claim 14, wherein the granular filter media comprises a ceramic, a sand, a glass, a zeolite, a garnet, an ilmentite, or any combination thereof.

18. The method of claim 14, wherein the granular filter media comprises a ceramic.

19. The method of claim 18, wherein the ceramic granular filter media has a zero or positive zeta potential at neutral pH.

20. The method of claim 14, wherein the granular filter media comprises a plurality of surface pores having a diameter of 500 nm to 75 μm.

21. The method of claim 14, further comprising passing water through a layer of low density filter media having an effective size that is larger than the effective size of the granular filter media.

22. The method of claim 21, wherein the layer of granular filter media is a downstream layer and the layer of low density filter media is an upstream layer.

23. The method of claim 21, wherein the low density filter media has an effective size of 0.5 mm or larger.

24. The method of claim 21, wherein the low density filter media comprises a carbonaceous material, a sand, a glass, a zeolite, a ceramic, or any combination thereof.

25. The method of claim 14, wherein the materials comprises microorganisms comprising Cryptosporidium ssp, Giardia ssp, or both.

26. The method of claim 14, wherein the filtering of materials occurs in an absence of chemical pretreatment.

27. The method of claim 14, wherein the water is sourced from recreational water.
